(19) United States
(12) Patent Application Publication
(10) Pub. No.: US 2016/0100436 A1
(43) Pub. Date: Apr. 7, 2016

(54) PROVIDING ACCESS TO A CRUISE SHIP NETWORK FROM A CONNECTION TO A SECONDARY NETWORK SEAMLESSLY

(71) Applicants: Vincent Cirel, Key Largo, FL (US); Melissa Good, Pembroke Pines, FL (US); Fidel Perez Cabrera, Coral Gables, FL (US); Arnold H. Bramnick, Boca Raton, FL (US)

(72) Inventors: Vincent Cirel, Key Largo, FL (US); Melissa Good, Pembroke Pines, FL (US); Fidel Perez Cabrera, Coral Gables, FL (US); Arnold H. Bramnick, Boca Raton, FL (US)

(21) Appl. No.: 14/504,197

(22) Filed: Oct. 1, 2014

(51) Int. Cl. H04W 76/02

(52) U.S. Cl. CPC H04W 76/02

(57) ABSTRACT

A system and method for providing access to a cruise ship network from a secondary network seamlessly is disclosed herein. The system includes a universal resource locator (URL) receiver to receive a URL from a mobile device connected to the cruise ship network or the secondary network; a connection detector to detect whether the mobile device is connected to the cruise ship network or the secondary network; an access retriever to retrieve an instruction based on the received URL and the detected connection; and a server transmitter to communicate the instruction to a server associated with the cruise ship network.

### BACKGROUND

Cruise ships provide a vacation experience for passengers on navigable waterways. The cruise ships allow the passenger to experience many different locales, both on land and sea. For example, a passenger may purchase a vacation or excursion from point A to point B (or from point A to point A), and during the traversal from one point to another, the cruise ship may stop at a variety of places in between.

In addition to providing transportation from one location to another, cruise ships also provide other services. In certain cases, the services may be electively chosen by each individual, and customized to each individual's needs and desires. In other cases, the services may be pre-selected by the cruise ship. In either case, the cruise ship and the passengers may require some sort of coordination between planning activities and events.

Prior to the advent of digital and mobile devices, a centralized computer may have been implemented. The computer would print out a passenger's itinerary. However, this implementation was not robust. For example, if a passenger on the cruise ship desired to change an activity, or select a new activity, a new printout or itinerary would have to be generated.

Recently, mobile devices have become more ubiquitous. A mobile device may be a smart phone, a tablet, a personal computer, a smart watch, or any sort of device known to one of ordinary skill in the art. A mobile device may be used in various ways with cruise ship vacations. For example, a calendar may be delivered electronically. In another implementation, the passenger may book, modify, cancel, or perform a whole host of activities associated with cruise ship travel and engagement. In another example, the cruise ship may employ an application to allow someone from the cruise ship's management or operation to engage with the passenger via a mobile application.

Thus, a digital itinerary may be presented to a passenger prior to the passenger boarding the cruise ship. Or the various applications discussed above may be electronically delivered via a network locally implemented onto the ship's computer (“a cruise ship network”). A passenger may configure a mobile device to connect to a local area network (LAN) access point, and engage with a centrally connected server on the ship.

When the passenger enters a port, for example, when the cruise ship has docked, the passenger may elect to connect their mobile device to a network provider on the port. In these situations, the network that the passenger is connected to may be separate or not associated with the LAN. For example, the passenger may employ a mobile device to connect to a wide area network (WAN), a satellite connected to an Internet, or the like.

### SUMMARY

Exemplary embodiments disclosed herein provide a method and system for providing access to a cruise ship network via a connection to a secondary network seamlessly. The system includes a universal resource locator (URL) receiver to receive a URL from a mobile device connected to the cruise ship network or the secondary network; a connection detector to detect whether the mobile device is connected to the cruise ship network or the secondary network; an access retriever to retrieve an instruction based on the received URL and the detected connection; and a server transmitter to communicate the instruction to a server associated with the cruise ship network.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### DESCRIPTION OF THE DRAWINGS

The detailed description refers to the following drawings, in which like numerals refer to like items, and in which:

FIG. 1 is a high-level block diagram illustrating an example computer.

FIG. 2 illustrates an example of a system for providing access to a cruise ship network seamlessly

FIG. 3 illustrates an example of a lookup table employed by the system described in FIG. 2.

FIG. 4 illustrates an example of a method for providing access to a cruise ship network seamlessly.

FIGS. 5(a) and (b) illustrate an example implementation of the system described in FIG. 2.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms including technical and scientific terms used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter, exemplary embodiments of the present invention will be described in detail with reference to the accompanying drawings. A membership management method according to an exemplary embodiment of the present invention may be performed by a membership management system; however, it is not limited to and may be incorporated in other systems and/or devices.

Cruise ships offer a plethora of services and activities for passengers to engage in. Thus, communicating with the passengers via electronic devices is becoming more commonplace. As explained in the Background section, employing a mobile device, such as those enumerated above, are one such way that a cruise ship may interact with passengers and the like.

When a passenger embarks onto a cruise ship, or signs onto a cruise ship's localized network, the passenger may be given permission to download data or an application through a connection with the ship's local area network (LAN). The passenger may enter in an authentication code (or provide any other sort of authentication technique known to one of ordinary skill in the art), and be given access to download data and applications associated with the cruise ship's operations and tangential activities.

For example, if the passenger downloads a reservation dining application, the passenger may be delivered information associated with the cruise ship's dining options. In turn, the passenger may order or view menus associated with on ship dining. In this way, a cruise ship's operators may communicate with a passenger via a securitized and localized network (LAN).

However, when the passenger goes to port, for example, when the cruise ship docks at a specific location, the passenger may exit the cruise ship. In doing so, the passenger may no longer be in communication with the cruise ship's LAN. The passenger may engage with another network, such as a wide area network (WAN), a satellite Internet connection, or the like.

The passenger may attempt to access the functionality associated with the application source from the cruise ship's servers and computers. However, due to security reasons, the cruise ship's operators may electively choose not to avail access to the cruise ship's servers and computers via a WAN connection or external network.

Thus, even though a cruise ship's passenger may have access to cruise ship data via an application, the passenger's access may be frustrated due to the passenger's mobile device not being connected to the cruise ship's networks or servers. For example, if the cruise ship's operators want to indicate that a reservation has changed, or provide reminders via the mobile application, the cruise ship's operator may not be able to effectively communicate to the passenger's mobile device.

One reason for this is that the application is configured to natively connect and interact with a LAN on the cruise ship. Due to this native connection, the application may be configured to attempt to connect to the LAN when initiated in a network outside or not in connection with the LAN. However, because the mobile device is no longer handshaking with the LAN, the connection becomes frustrated.

Disclosed herein are methods and systems for providing access to a localized network from a connection to a secondary network in a seamless way. The aspects described herein may be employed in the context as described above.

A mobile device initially connected to a LAN, allows an operator of the mobile device to download proprietary data or applications associated with the interaction of mobile device user and the onboard servers associated with a cruise ship. Once the mobile device is off the cruise ship, or connected to an external network (for example a WAN or a satellite internet connection), in response to the mobile device user accessing data or an application associated with the cruise ship's operation, the mobile device user is seamlessly connected to the cruise ship's servers and network. The mobile device user's engagement with the cruise ship originated applications may be independent of any sort of command indicating that the mobile device user is no longer connected to the cruise ship's LAN.

Thus, employing the aspects described herein, the cruise ship traveler is provided an opportunity to engage with the cruise ship even when not connected to the cruise ship's LAN. In turn, the cruise ship's operators are provided an option of sharing and interacting with the mobile device user in a secure and efficient manner.

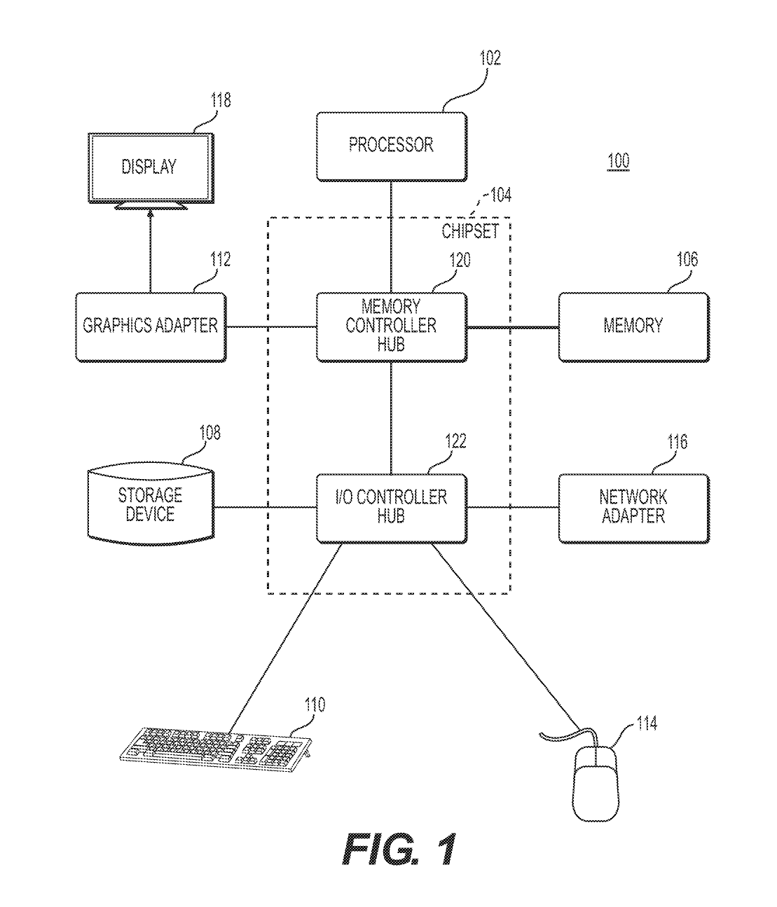

FIG. 1 is a high-level block diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer system 100. The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a video corpus, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

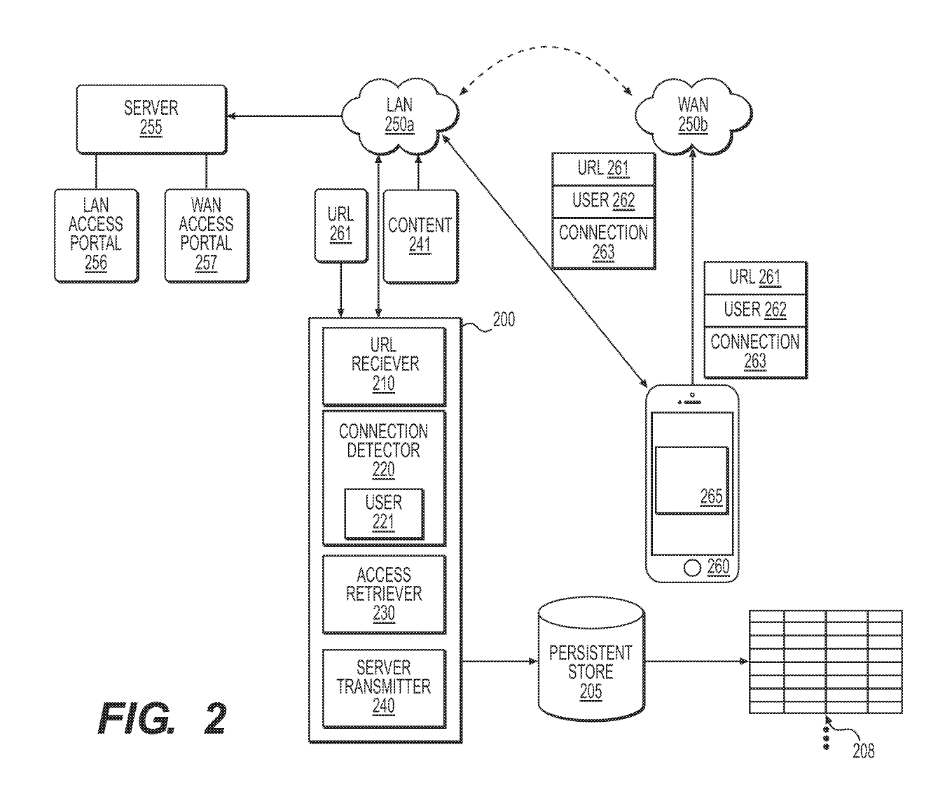

FIG. 2 illustrates an example of a system 200 for providing access to a cruise ship network seamlessly. The system 200 includes a URL receiver 210, a connection detector 220, an access receiver 230, and a server transmitter 240. The system 200 may be implemented on a device, such as computer 100 described above.

Also shown in FIG. 2 is a persistent store 205. The persistent store 205 may be any of the storage devices 108 enumerated above, or any electronic storage technique known to one of ordinary skill in the art. The persistent store 205 may be integrated with system 200, or provided as a stand-alone element.

Referring to FIG. 2, a server 255 is shown. The server 255 may installed on the premise of a cruise ship. The server 255 is standard computing device that provides data to various devices that connect remotely to the server 255.

The LAN 250a services the server 255, users connected to the server 255, and other operations. A user may access the server 255, via LAN 250a, by employing a mobile device 260.

For example, the mobile device 260 may request through a universal resource locater (URL) 261, and access to a specific application server 256 stored on the server 255. The URL 261 may be sent through a communication channel established between the mobile device 260 and the LAN 250A. Based on the URL 261 received, the LAN 250a may transmit information from the LAN access portal 256.

In an example implementation, the mobile device 260 may connect to LAN 250a, receive information from server 255 based on information stored on a LAN access portal 256. The LAN access portal 256 may be a locally stored content server that provides information, applications, and engagement functionality with a cruise ship's operation. Once the mobile device 260 handshakes with the LAN access portal 256 (via LAN 250A), the mobile device 260 may interact with various functions associated with and provided by the cruise ship.

The server 255 is connected to the LAN 250a, and primarily accessed through the LAN 250a. However, because the server 255 is implemented on a cruise ship, in certain situations, the server 255 may interact with a WAN 250b or a secondary network. For example, if the cruise ship in which server 255 is implemented on is docked at a specific port or destination, the LAN 250a may connect to a WAN 250b, and allow parties connected to the WAN 250b to communicate and access various services, data, and applications via the server 255.

For example, if a passenger aboard the cruise ship leaves the ship to travel on a port, the passenger may bring along a mobile device 260. The mobile device 260 may establish a connection with WAN 250b via an access point (for example, a wireless Internet connection publically provided, or the passenger's own Internet connection via a satellite). The passenger's mobile device at this juncture may connect via the WAN 250b to the LAN 250a through the bridge established above.

The URL receiver 210 receives, via LAN 250a, a URL 261. The URL 261 is an identifier that specifies a location associated with server 255 for a specific application, server, or data associated with the cruise ship. For example, the URL 261 may be ‘reservations.cruiseship.com’—and in response to receiving this URL 261, the LAN 250a may deliver content from a source (for example, via LAN access portal 256) to deliver content to the mobile device 260 (i.e. the originating source of the URL 261). Once the URL 261 is received, the URL 261 may be stored in persistent store 205, and recalled at a later juncture, or by any of the other elements associated with system 200.

As explained above, the URL 261 may be sourced from a connection to LAN 250a or WAN 250b. The server 255 may be cognizant of this based on a monitoring associated with network connections associated with LAN 250a.

The connection detector 220 detects the type of connection associated with the mobile device 260's URL 261 request. As explained above, the connection detector 220 may determine this information via knowledge ascertained by server 255. In another example, the connection information 263 may be provided along with the URL 261. In either example, the connection detector 220 detects the connection type (for example, via LAN 250a or WAN 250b).

In another implementation, the connection detector 220 may include a user detector 221. The user detector 221 detects the user associated with mobile device 260. When a user installs an application sourced from the server 255, the user may provide their information (for example, via an authentication process), and register usage of the application 265 with server 255. Thus, in addition to the URL 261 and/or the connection 262, the mobile device 260 may transmit an identity of the user 263 associated with mobile device 260.

The access retriever 230 retrieves an access associated with the ascertained information from the URL receiver 210 and the connection detector 220.

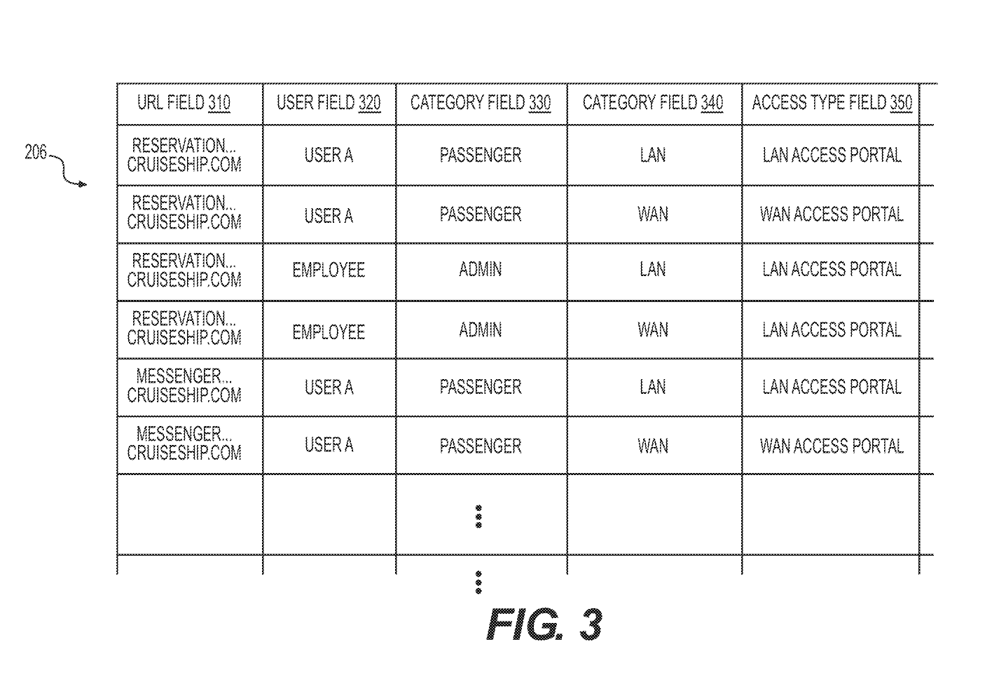

FIG. 3 illustrates an example lookup table 206. The example shown is for explanation purposes, and one of ordinary skill may implement the aspects described herein with other variations. For example, lookup table 206 includes a permission field, which allows a specific user to access a LAN access portal 256 from a WAN 250b connection. However, the aspects described herein may omit this field in an implementation of lookup table 206. Lookup table 206 may be implemented in any sort of known digitalized database or data storing technique.

The lookup table 206 includes a URL field 310, a user field 320, a user category field 330, a connection field 340, and access type 350. As shown in FIG. 3, each type of user and connection is associated with a specific access type. For example, user A, when connecting to the server 255 via LAN 250a, is served content via LAN access portal 256. In another example, user A, when connecting to server 255 via WAN 250b, is served content from the WAN access portal 257.

In providing a sort of firewall or separation between the WAN access portal 257, the cruise ship's operators may effectively provide access to certain functionality associated with URL 261 request (and general engagement with the server 255), while securely separating access to certain aspects of the server 255 based on the network connection.

Another advantage of the above-described implementation is that a user or application employs a singular URL 261 (for example, while on the cruise ship or off the cruise ship). In an example, if the mobile device 260's user is on a port, and visiting a local coffee shop—if the URL 261 is entered on the mobile device 260 to access the services associated with URL 261, the mobile device 260 is redirected to the appropriate portal independent of any sort of intervening actions required by the user.

After the access retriever 230 retrieves the access portal or the content in which the mobile device 260 is to receive, the server transmitter 240 transmits this information to server 255. Server 255 may then serve application 265 to mobile device 260 with information and content from the selected access portal (for example LAN access portal 256 or WAN access portal 257). The server transmitter 240 communicates the content 241 to the server 255. The content 241 may serve to instruct the server 255 an instruction as to what content, data, or applications to deliver.

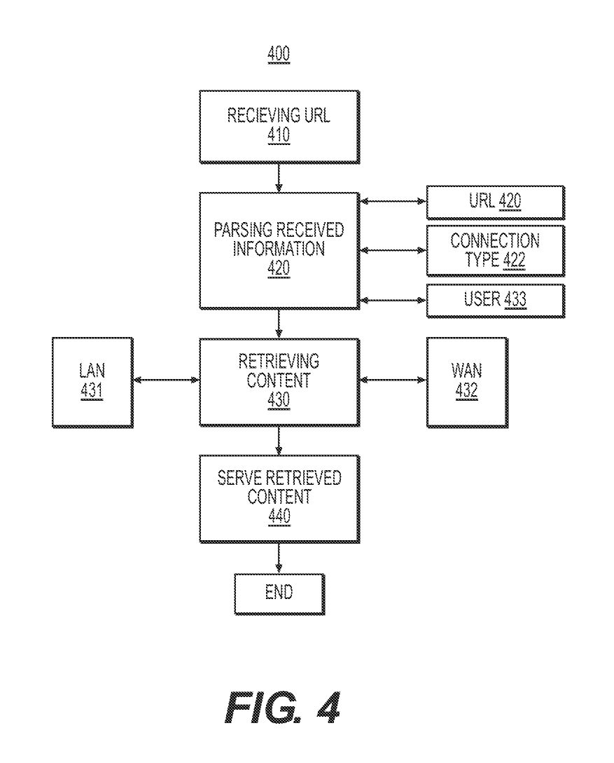

FIG. 4 illustrates an example of a method 400 for providing access to a cruise ship network from a secondary network seamlessly. The method 400 may be implemented on a processor or device, such as those enumerated above. The processor or device may be implemented in accordance with, or integrated with a server, such as server 255.

In operation 410, a URL is received from a generating device (for example, mobile device 260). The generating device my initiate the URL via an application provided from the server 255 when the mobile device 260 is in a network situation facilitated by a LAN connection. The URL may be transmitted along with other information, such as a connection type associated with the request, and user information.

In operation 420, the received information is parsed. Depending on the implementation, a URL may be extracted (421), a connection type may be extracted (422), and a user may be extracted (423). Operations 421-423 may be electively provided. An implementer of method 400 may employ other techniques associated with ascertaining the information discussed above. For example, if the method 400 is installed or implemented on a server 255, the server 255 may be configured to ascertain a connection type based on an existing network connection between a server 255 and a mobile device 260.

In operation 430, based on the parsed information, content to serve is retrieved. The retrieval of content may encompass a technique in which a lookup table (such as lookup table 206) is correlated with the identified information ascertained in operation 420. Accordingly, based on at least one of a URL, connection type, and user, the content associated with the specific case is retrieved. As explained above, the content being retrieved may be determined based on a lookup table 206 shown in FIG. 3. The lookup table 206 correlates various factors associated with the user, connection type, or the like. For example, a LAN access portal may be retrieved (431), or a WAN access portal may be retrieved (432).

In operation 440, the retrieved content is served to a user associated with mobile device 260. The mobile device 260 may interface or handshake with a server, such as server 255. Server 255 may serve content associated with the cruise ship's operation and services. Thus, employing the concepts disclosed herein, a user or an application may provide a singular URL 261 via a network connection. The network connection may re-direct the user to a LAN access portal that the user was previously connected to. All of this may be independent of a user entering in a new URL. Thus, a device employing method 400 may be able to ascertain the connection type based on other indicia, and thus, detect that the user is no longer on a cruise ship.

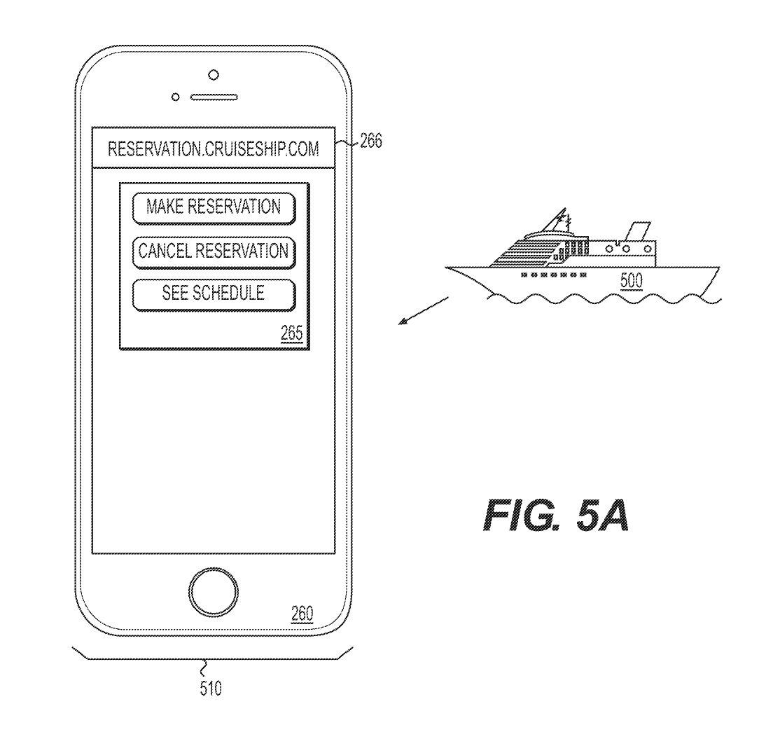

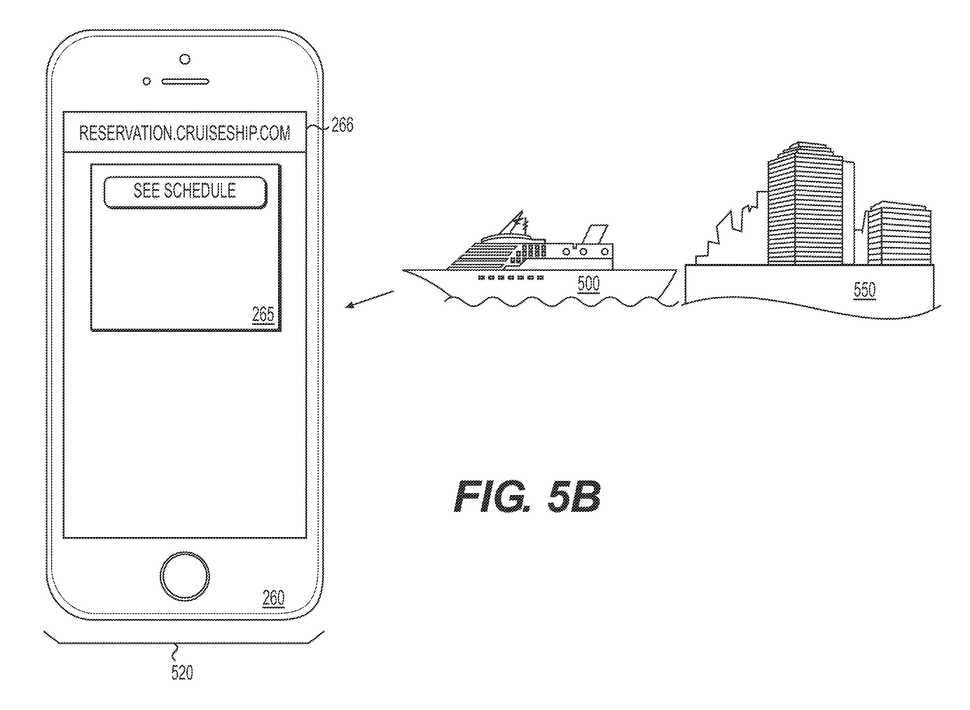

FIGS. 5(a) and (b) illustrate an example implementation of the system 200. Referring to FIGS. 5(a) and (b), a mobile device 260 is shown in a state 510 and a state 520, respectively.

In FIG. 5(a), a cruise ship 500 is out at sea or in a situation where a LAN 250a is either primary provider of a network connection, or a sole provider of a network connection. Mobile device 260 may download content, data, or an application from a server 255. As shown in FIG. 5(a), the mobile device 260 is displaying an application 265 associated with reservations/scheduling. The mobile device 260 includes a reference bar 266, which is configured to allow a user associated with mobile device 260 to enter in a URL 261. In another example, the URL 261 may be automatically called for by an operation of the mobile application 265 (for example, in response to an icon or GUI associated with the mobile application 265 being asserted).

Mobile device 260 is presently being served data via LAN 255a. In the example shown, the mobile application 265 includes several options, such a ‘make reservation’, ‘cancel reservation’, and ‘see schedule’. In state 510, i.e. when the mobile device 265 is connected to a server 255 via LAN 250a, the application 265 provided may include the options and functions shown in FIG. 5(a).

In FIG. 5(b), the cruise ship 500 is now ported to a dock 550. A LAN 250a may be bridged to a WAN 250b. The user associated with the mobile device 260 may enter the dock 550, and connect to a WAN 250b through various connectivity options. Thus, the user may access the WAN 250b in a coffee shop, a hotel, through a satellite connection, or the like.

Employing the aspects described herein, the mobile device 260 may be instructed to execute the mobile application 265. However, because system 200 is implemented on the cruise ship 500, the user does not have to enter a different URL 261 to access content, data, or applications associated with the cruise ship 500's server 255.

As shown in FIG. 5(b), a mobile application 265 is served to mobile device 260. However, several of the options disclosed in FIG. 5(a) are omitted. In this implementation, different content is provided to a passenger based on a connection type. This scenario is merely exemplary, and one of ordinary skill in the art may modify a lookup table 206 to provide a customized experience based on an implementer's preference.

Thus, employing the aspects disclosed herein, a cruise ship may provide a localized network experience to an passenger when the passenger is located on a cruise ship, while providing similar experiences and content to the same passenger when the passenger is located on a dock. Because the passenger does not have re-enter a URL or specific identifier in a specific network context, the transition of a user experience from a cruise ship to a non-cruise ship location becomes seamless.

Certain of the devices shown in FIG. 1 include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIG. 4. The disclosed devices, components, and systems contemplate using or implementing any suitable technique for performing the steps illustrated in these figures. Thus, FIG. 4 is for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

We claim:

1. A system for providing access to a cruise ship network from a secondary network seamlessly, comprising:
a data store comprising a computer readable medium storing a program of instructions for the providing of access;
a processor that executes the program of instructions;
a universal resource locator (URL) receiver to receive a URL from a mobile device connected to the cruise ship network or the secondary network;
a connection detector to detect whether the mobile device is connected to the cruise ship network or the secondary network;
an access retriever to retrieve an instruction based on the received URL and the detected connection; and
a server transmitter to communicate the instruction to a server associated with the cruise ship network.

2. The system according to claim 1, wherein the instruction indicates access to a first access portal or a second access portal based on the detected connection.

3. The system according to claim 1, further comprising detecting user data associated with the mobile device, and retrieving the instruction based on the received URL, detected connection, and the user data.

4. The system according to claim 1, wherein the secondary network is a wide area network (WAN) and the cruise ship network is a local area network (LAN).

5. The system according to claim 1, wherein the URL is requested via a mobile application installed on the mobile device.

6. The system according to claim 2, wherein the URL to access the first portal and the URL to access the second portal is the same.

7. The system according to claim 4, wherein the cruise ship network and the secondary network bridge together in response to a cruise ship associated with the cruise ship network being at a port.

8. The system according to claim 2, wherein the first access portal and the second access portal provide a different level of access from each other.

9. A method for providing access to a cruise ship network from a secondary network seamlessly, comprising:
receiving a universal resource locator (URL) from a mobile device accessing the cruise ship network directly, or via a bridge from the secondary network to the cruise ship network;
parsing the received information to obtain at least the URL and the connection type associated with the mobile device and a server associated with the cruise ship network connection;
retrieving content based on the URL and the connection type; and
serving the content to the mobile device,
wherein at least one of the receiving, parsing, retrieving, and serving is performed via a processor.

10. The method according to claim 9, wherein the retrieving of content further comprises accessing either a first access portal or a second access portal based on the connection type.

11. The method according to claim 9, further comprising detecting user data associated with the mobile device, and retrieving the content based on the received URL, detected connection, and the user data.

12. The method according to claim 9, wherein the secondary network is a wide area network (WAN) and the cruise ship network is a local area network (LAN).

13. The method according to claim 9, wherein the URL is requested via a mobile application installed on the mobile device.

14. The method according to claim 10, wherein the URL to access the first portal and the URL to access the second portal is the same.

15. The method according to claim 14, wherein the cruise ship network and the secondary network bridge together in response to a cruise ship associated with the cruise ship network being at a port.

16. The method according to claim 10, wherein the first access portal and the second access portal provide a different level of access from each other.
